(19) United States
(12) Patent Application Publication
(10) Pub. No.: US 2020/0219294 A1
(43) Pub. Date: Jul. 9, 2020

(54) Sound Actuated Augmented Reality

(71) Applicant: Google LLC, Mountain View, CA (US)

(72) Inventors: Ibrahim Badr, Zurich (CH); Roza Chojnacka, Mountain View, CA (US)

(21) Appl. No.: 16/727,337

(22) Filed: Dec. 26, 2019

Related U.S. Application Data
(60) Provisional application No. 62/790,284, filed on Jan. 9, 2019.

(51) Int. Cl. G06T 11/00; G10L 15/18; G10L 15/22

(52) U.S. Cl. CPC G06T 11/00; H04N 7/157; G10L 15/22; G10L 15/1815

(57) ABSTRACT

A system and method for creating an augmented reality (AR) environment are disclosed. AR effects are determined based on events detected in captured audio and combined with captured video to create an AR environment for an application. The resulting AR experience is triggered, generated, altered or otherwise controlled by sound, such as speech.

### CROSS-REFERENCE TO RELATED APPLICATION

This application claims the benefit of U.S. Provisional Application No. 62/790,284, filed on Jan. 9, 2019, the contents of which are entirely incorporated by reference.

### FIELD OF THE DISCLOSURE

The present disclosure relates to an augmented reality (AR) experience. More specifically, the disclosure relates to an AR experience environment that is actuated (e.g., triggered, generated, altered, and/or otherwise controlled) by sound, such as speech.

### BACKGROUND

In the context of computer-based consumption of media and other content, it is becoming increasingly common to provide a user (viewer, participant, etc.) with an immersive experience through an AR experience. The AR experience includes at least the presentation (e.g., display) of an environment that includes sensed elements corresponding to a real environment combined (e.g., overlaid) with rendered elements corresponding to a virtual environment in a realistic way in order enhance user's interaction with an application running on a computing device. The enhancements may be directed to conveying more information, enhancing entertainment, and/or simplifying interaction.

### SUMMARY

This disclosure describes systems and methods for creating an AR environment in which a sound, such as speech, can trigger, generate, alter, or otherwise control AR effects in the AR environment. For example, a user's speech may be used to trigger/control virtual elements rendered and combined (i.e., overlaid) with real elements captured in a streaming video.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for providing a sound actuated AR environment according to a possible implementation of the present disclosure.

FIG. 2 graphically depicts an example of an AR experience according to a possible implementation of the present disclosure.

FIG. 3A is a first screen capture of a sound actuated AR environment in a possible application of the present disclosure.

FIG. 3B is a second screen capture of a sound actuated AR environment in a possible application of the present disclosure.

FIG. 3C is a third screen capture of a sound actuated AR environment in a possible application of the present disclosure.

FIG. 4 is a flow chart of a method for creating a sound actuated AR environment according to a possible implementation of the present disclosure.

FIG. 5 shows an example of a computer device and a mobile computer device that can be used to implement the techniques described here.

Like reference symbols in the various drawings indicate like elements.

### DETAILED DESCRIPTION

The present disclosure describes systems and methods for triggering, rendering, and updating an AR environment. In conventional AR experiences, the layout of sensed real elements (i.e., visually recorded physical objects) and rendered virtual elements (i.e., computer-generated virtual objects) in an AR environment is determined by an application based on inputs from a camera and one or more position sensors.

In general, one technical problem that may arise when presenting an AR experience is the AR environment does not correspond to an input from an audio sensor (i.e., microphone). For example, conventional AR environments may fail to render and/or control virtual elements based on audio data received by a computing device

The systems and methods described herein may provide a technical solution to the above technical problem by providing an AR experiences that can be triggered by and/or respond to audio input. For example, speech from a user can trigger and/or control AF effects to improve variety of applications, including (but not limited to) applications for entertainment (e.g., gaming, chat) and applications for shopping (e.g., clothing try-on, placing furniture, etc.).

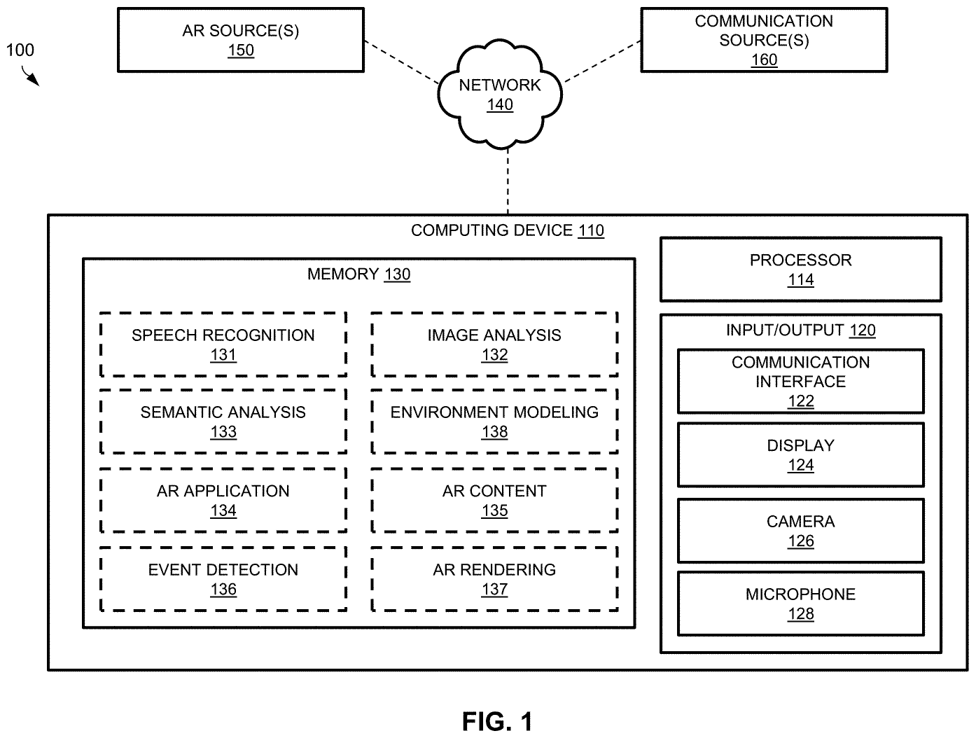

FIG. 1 is a block diagram illustrating a system 100 for providing an AR environment according to an example implementation of the present disclosure. The system 100 can generate and present an augmented reality (AR) environment to a user based on inputs received at a computing device 110. The computing device 110 can be embodied as a portable device, such as a smartphone, a tablet or a laptop. Alternatively, the computing device can be embodied as a fixed-location device, such as a desktop computer or virtual assistant appliance.

The computing device 110 includes a processor assembly 114 (i.e., processor) that can be configured by computer readable instructions (e.g., computer program, program component, program stack, application, etc.) to cause the computing device to generate an audio enabled/enhanced AR experience. In some implementations, the processor 114 can include a central processing unit (CPU) and a graphics processor unit (GPU). In these implementations, some image/video rendering tasks, such as rendering/displaying AR objects may be offloaded from the CPU to the GPU.

The computing device 110 may include a memory 130 (e.g., a non-transitory computer readable medium) for storing computer readable instructions. For example, the memory 130 may include one or more program components and/or data directed to speech recognition 131, image analysis 132, semantic analysis 133, environment modeling 138, AR application 134, AR content 135, event detection 136, and AR rendering 137.

The computing device 110 also includes an input/output subsystem 120 (i.e., input/output) for receiving sensor inputs and for providing outputs. The input/output 120 may include one or more sensors for obtaining location information (e.g., global positioning sensor), position information (e.g., accelerometer), visual information (e.g., camera 126), audio information (e.g., microphone 128), and/or user input (e.g., buttons, touch screen). The input/output 120 may also include output devices for communicating with a user (e.g., display 124, speaker, indicators) or with other devices (e.g., communication interface 122).

The computing device 110 may be communicatively coupled to other devices via a wired connection (e.g., a Universal Serial Bus (USB) cable) or via a wireless communication protocol (e.g., any WiFi protocol, any Bluetooth protocol, Zigbee, etc.). For example, the computing device 110 may be coupled to a network 140 (e.g., LAN, WAN, cellular, etc.) to exchange information with one or more AR sources 150 and/or one or more communication sources 160.

The one or more communication sources 160 may be other computing devices used by other users. For example, communication between the computing device 110 and a communication source 160 over the network 140 may include a video chat between two users.

The one or more AR sources 150 may include cloud servers and/or services to enable one or more functions of the AR experience for the computing device 110. For example, one or more of the speech recognition 131, image analysis 132, semantic analysis 133, environment modeling 138, AR application 134, AR content 135, event detection 136, and AR rendering 137 may be performed entirely or partially by the one or more AR sources 150 (i.e., remotely) instead of by the computing device 110 (i.e., locally).

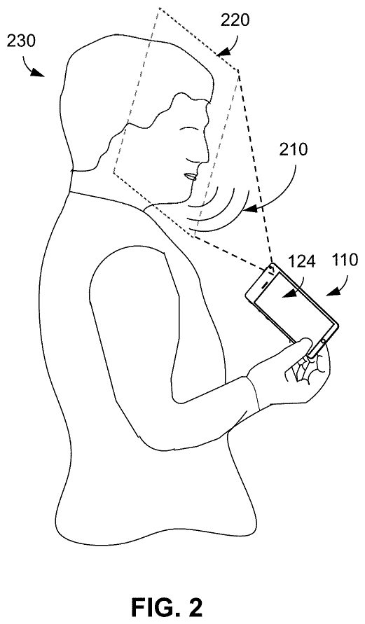

FIG. 2 illustrates some aspects of an example AR experience according to an implementation of the present disclosure. As shown, a user 230 may position a computing device 110 (e.g., smartphone) to view an AR environment on the display 124. The AR environment can be part of a user interface (UI) for an application (e.g., video chat) running on the computing device 110. The AR environment can include a scene captured (e.g., as a live stream) from the field of view 220 of the camera 126 and computer-generated virtual elements that are combined (e.g., overlaid) with real elements to provide additional meaning, function, and/or decoration to the scene and/or to real elements within the scene. The virtual elements may be registered with the real elements (e.g., surfaces, features) so that as field of view 220 is repositioned, the virtual elements move as the real elements. The virtual elements may be rendered as flat elements or as elements with a three-dimensional effect based on depth information obtained from the field of view 220. The depth information may be obtained in various ways. For example, multiple cameras positioned apart on the computing device 110 can obtain depth information from a scene. Alternatively, depth sensors of the computing device 110 that are based on LIDAR or structured light may be used to obtain depth information from a scene.

As shown in FIG. 2, at least one microphone 128 of the computing device 110 can receive sounds during the AR experience. For example, the sounds may include ambient sounds that are not necessarily intended for the microphone (e.g., thunder, rain, traffic, wind, music, etc.) and/or intentional sounds that are intended for the microphone (e.g., voice, speech, singing). In a possible implementation, speech 210 from a user 230 may be detected and analyzed (e.g., recognized) by the computing device 110 to trigger, generate, update, delete, or otherwise control aspects of the AR environment. One possible application that utilizes this implementation is video conferencing (i.e., video chat).

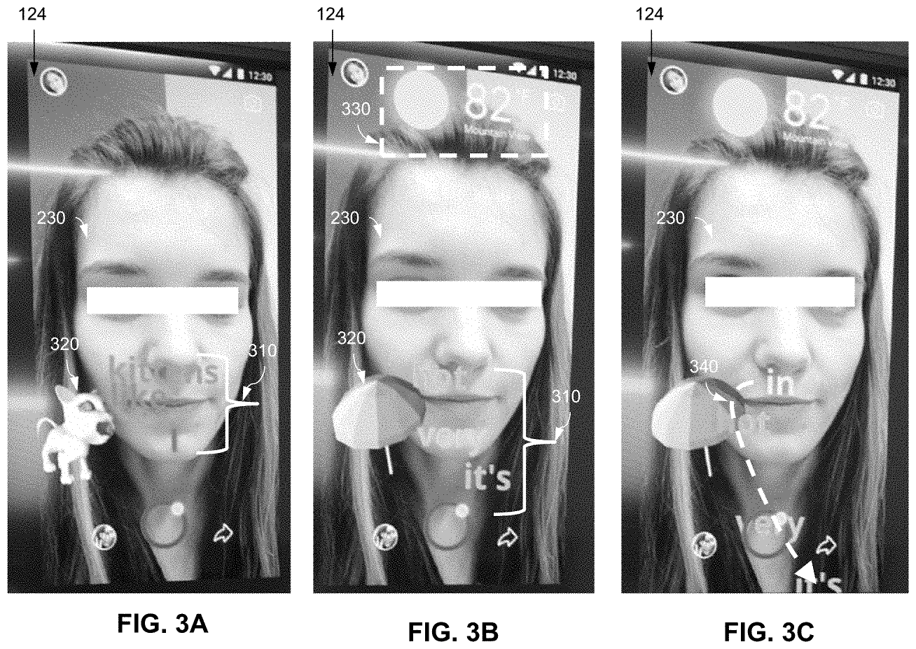

FIGS. 3A-3C depict screen captures of a sound actuated AR environment for a video chat AR application 134. In this implementation, a first user and a second user exchange sound and video over a network 140. As each user speaks, speech recognition 131 software, running on each user's respective computing device (or running on an AR source 150), recognizes words. In some implementations, the speech recognition 131 may simply detect certain words when they are spoken. Implementations that are more complex, however, may create a transcript for the conversation from the speech recognition, and in some cases, the transcript can be diarized to classify the portions spoken by each user. In these implementations, the transcripts may be analyzed by semantic analysis 133 software to determine meaning from the transcripts. At the same time, image analysis 132 software analyzes video captured by the camera 126 to detect features (e.g., faces, surfaces, objects, etc.) with the field of view 220 of the respective cameras. From the detected surfaces, a virtual environment may be generated for each (or both) users by environment modeling 138 software.

The word recognition of the speech recognition 131 and/or meaning recognition of the semantic analysis 133 is input to event detection 136 software. The event detection software can classify the input to determine that one or more events corresponding to stored AR content 135 have occurred. After the event(s) and the corresponding AR content have been determined, virtual elements may be combined with real elements according to the virtual environment by AR rendering software 137 to create an AR environment that is presented on a user's screen to create an AR experience for the user.

A display 124 of a computing device 110 participating in a video chat is shown in FIG. 3A. As a user 230 speaks, a virtual element in the form of text corresponding to the user's spoken words 310 appear proximate to the user's mouth as the user speaks (e.g., in real time). Additionally, a virtual element in the form of an illustration or animation corresponding to the meaning of the user's spoken words 320 appears on the display. In the example shown in FIG. 3A, as the user 230 says, “I like kittens” an animation of a kitten appears next to the user 230. Later, shown in FIG. 3B, as the user 230 says, “It's very hot,” the text corresponding to the user's spoken words 310 is updated and the illustration or animation corresponding to the meaning of the user's spoken words 320 is updated to represent a sun umbrella. Additionally, a virtual element in the form of a weather forecast 330 appears on the display in response to either the word “hot” or in response to the determined meaning of the phrase, “it's very hot.”

Updating the virtual elements may include adding, subtracting, moving, sizing, coloring, or any other change to the virtual element or how it is displayed. For example, returning to the example application of video chat in FIG. 3C, the AR text that appears at the user's mouth may be move along a path 340 as the user speaks to illustrate speech flow, as shown in FIG. 3C.

The virtual elements and their corresponding triggers are only examples of the possible virtual elements and triggers that the system 100 may enable. The disclosure is not limited to these examples. For example, speech need not be used as the trigger for a virtual element. For example, a blowing noise could trigger bubbles to emerge and flow from the user's mouth. The possibilities for virtual elements and their corresponding triggers may include all such entertaining and/or informative visual information that implies some meaningful correlation with a sound.

The application of video chat is only one possible application that the sound actuated AR may be applied to any application that combines video and sound. These applications may serve various purposes including (but not limited to) entertainment (e.g., chat, gaming, social media, etc.), commerce (e.g., shopping), and business (e.g., advertising). For example, virtual elements in an AR environment may be controlled through speech. In one possible implementation, a user may use an AR environment to try-on an article of clothing or an accessory (e.g., glasses) before buying. In this implementation, a user may use voice commands to change or alter the article or accessory. For example, the user may change the color of a pair of glasses by saying, “make them green.” The disclosed systems and methods include the algorithms (i.e., software) necessary to understand the meaning of this speech without requiring the user to conform their speech to a particular set of commands. Additionally, the modeled environment can provide the context for the meaning (i.e., virtual element=“them”).

The processor 114 (or processors) of the computing device may be configured by software instructions (e.g., stored in the memory 130) to perform one or more steps of a method for providing a sound actuated (e.g., triggered, controlled, enabled, etc.) AR environment, and any steps of the method that not performed by the processor may be performed by a device coupled to the network (e.g., AR source 150, communication source 16). In other words, portions (or all) of the operations for providing an AR environment may be performed in the cloud.

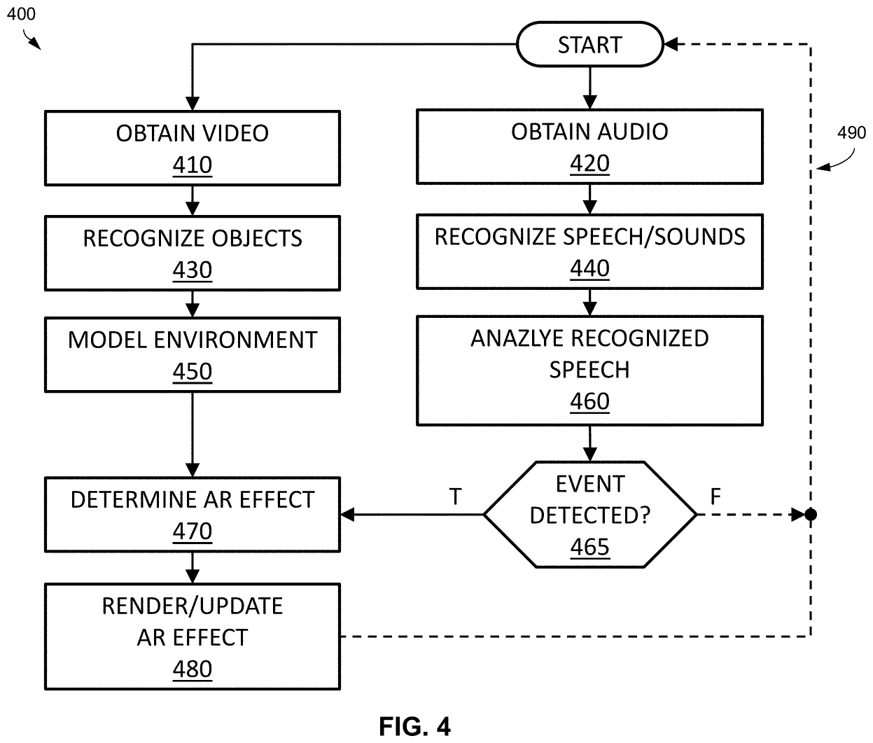

FIG. 4 is a flow chart of a method 400 for creating an AR environment according to a possible implementation of the present disclosure. In the method 400, video from a field of view 220 of the camera 126 and audio from a microphone 128 is obtained 410, 420 (e.g., received, captured) at the computing device 110. The video and the audio can be processed and analyzed simultaneously to produce a real time result. From the analysis, objects may be recognized 430 in the video. In some implementations, the operation of recognizing objects 430 may include image recognition algorithms (e.g., GOOGLE LENS™) based on coarse grain labeling to recognize an object type (e.g., the object is a face) and specialized components to recognize a particular feature of the object (e.g., the face is John Doe).

Next in the method 400, the video may be analyzed by algorithms (e.g., ARCORE™, ARKIT™) to model 450 an environment. The modeling 450 of the environment can include spatially orienting and sizing objects and their locations (e.g., via bounding boxes) to determine information about the detected objects and their environment. In some implementations, the operation of modelling 450 can also include motion tracking and an estimating of the current lighting conditions. In implementations that include multiuser environments, modeling information may be shared (e.g., between computing devices over the network 140) to help create a composite environment.

Also in the method 400, audio from the microphone may be obtained 420 processed to recognize 440 speech (e.g., automatic speech recognition (ASR), speech to text (STT)) and/or sounds 440. In some implementations, the operation of recognizing 440 speech/sounds includes algorithms based on deep learning (e.g., CLOUD SPEECH-TO-TEXT™). In some implementations, each word in the recognized speech may be converted into a virtual element for the AR environment.

Next in the method 400, the recognized speech (e.g., speech transcript) is analyzed 460 to determine if there are any words or phrases that correspond to an event associated with an AR response. If an event is detected 465, then the AR effect corresponding to the event is determined 470 an AR effect (e.g., a virtual element and its associated features/behavior) is rendered 480 and presented on the display 124 of the computing device 110 to create an AR experience for the user 230. In general, an AR effect may be visual, auditory, and/or haptic.

The operations in the method 400 may be repeated 490 (e.g., for as long as the application is running or based on an input from a user) to update 480 the AR effect based on new information. For example, new sounds or speech may be used to control an aspect of the AR effect. Alternatively, new video may be used to control an AR effect. In a possible implementation, changes in the field of view (e.g., the movement of a face) can control an AR effect (e.g., the words coming from the user's mouth shifted with the face).

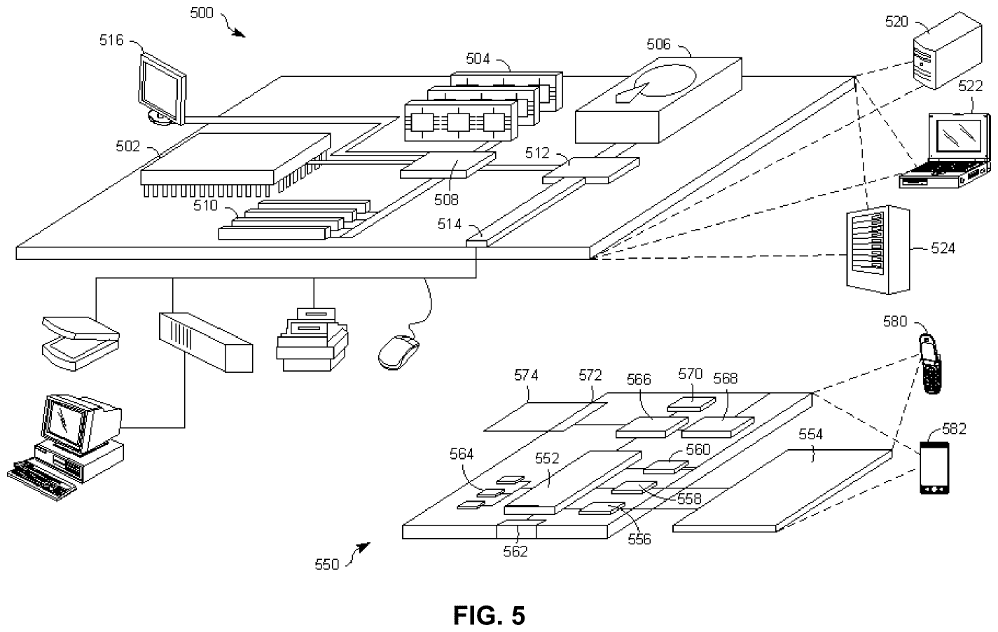

FIG. 5 shows an example of a generic computer device 500 and a generic mobile computer device 550, which may be used with the techniques described here. Computing device 500 is intended to represent various forms of digital computers, such as laptops, desktops, tablets, workstations, personal digital assistants, televisions, servers, blade servers, mainframes, and other appropriate computing devices. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. The processor 502 can be a semiconductor-based processor. The memory 504 can be a semiconductor-based memory. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550 or may also store applications or other information for device 550. Specifically, expansion memory 574 may include instructions to carry out or supplement the processes described above and may include secure information also. Thus, for example, expansion memory 574 may be provided as a security module for device 550 and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method for creating an augmented reality (AR) environment, the method including:
obtaining audio and video from a field of view;
recognizing speech in the audio;
analyzing the recognized speech to detect an event;
determine an AR effect based on the detect event; and
render the AR effect with the video to create an AR environment.

2. The method according to claim 1, wherein the AR effect is rendered in real time with the audio and video.

3. The method according to claim 1, wherein the obtaining comprises capturing video from a camera and simultaneously recording audio from a microphone, the camera and the microphone included in a computing device.

4. The method according to claim 1, wherein the obtaining audio and video includes receiving the audio and video from a network.

5. The method according to claim 1, wherein the analyzing the recognized speech includes semantic analysis.

6. The method according to claim 1, wherein the event is a recognized word.

7. The method according to claim 1, wherein the AR effect is a virtual element presented on a display.

8. The method according to claim 7, wherein the virtual element is one or more of a text, an icon, an animation, an image, or a video.

9. The method according to claim 1, wherein the AR environment is part of a video chat application.

10. A computing device comprising:
one or more cameras configured to capture video from a field of view;
one or more microphones configured to capture audio;
a memory; and
a processor communicatively coupled to the one or more cameras, the one or more microphones, and the memory, wherein the processor is configured by software to:
present an augmented reality (AR) environment on a display of the computing device based on the captured video and the captured audio.

11. The computing device according to claim 10, comprising a communication interface for communication with a network.

12. The computing device according to claim 11, wherein the computing device is further configured to:
receive at least a portion of the AR environment from the network.

13. The computing device according to claim 10, wherein the AR environment includes computer generated virtual elements combined with real elements imaged using the one or more cameras.

14. The computing device according to claim 10, wherein the audio is speech.

15. The computing device according to claim 14, wherein the processor is further configured to detect an event based on a word recognized in the speech, the AR environment based on the recognized word.

16. The computing device according to claim 14, wherein the processor is further configured to:
determine a meaning from the speech; and
detect an event based on the determined meaning, the AR environment based on the determined meaning.

17. A system device comprising:
one or more augmented reality (AR) sources; and
a computing device including:
one or more cameras configured to capture video from a field of view;
one or more microphones configured to capture audio;
a memory;
a communication interface that communicatively couples the computing device to a network including the one or more AR sources; and
a processor communicatively coupled to the one or more cameras, the one or more microphones, the memory, and the communication interface, wherein the processor is configured by software to:
present an AR environment on a display of the computing device based on the captured video and the captured audio.

18. The system according to claim 17, wherein the one or more AR sources provide at least a portion of the AR environment.

19. The system according to claim 17, wherein the one or more AR sources are configured to:
receive the captured audio and the captured video from the computing device;
determine a virtual element for the AR environment based on the captured audio and the captured video; and
transmit the virtual element to the computing device.

20. The system according to claim 17, wherein the computing device is a smartphone, a tablet, or a virtual assistant appliance.
